(19) United States
(12) Patent Application Publication
(10) Pub. No.: US 2022/0093039 A1
(43) Pub. Date: Mar. 24, 2022

(54) BRIGHTNESS COMPENSATION METHOD APPLIED TO ORGANIC LIGHT-EMITTING DIODE DISPLAY

(71) Applicant: Raydium Semiconductor Corporation, Hsinchu (TW)

(72) Inventors: Shang-Ping Tang, Hsinchu City (TW); Hung Li, Taipei City (TW); Feng-Li Lin, Hsinchu City (TW)

(21) Appl. No.: 17/476,516

(22) Filed: Sep. 16, 2021

Related U.S. Application Data
(60) Provisional application No. 63/081,952, filed on Sep. 23, 2020.

(51) Int. Cl. G09G 3/3208; G09G 5/10

(52) U.S. Cl. CPC G09G 3/3208; G09G 2320/064; G09G 5/10

(57) ABSTRACT

A brightness compensation method applied to an OLED display is disclosed. The brightness compensation method includes following steps of: (a) using a skip frame method or an extend porch method to reduce a display frame rate of the OLED display from a first frame rate to a second frame rate, wherein the first frame rate is higher than the second frame rate; and (b) compensating pulse widths of N light-emitting control pulses corresponding to a repeat frame or an extended porch not refreshed, wherein the N light-emitting control pulses correspond to N compensation values, N≥1 and the N compensation values are positive or negative.

### BACKGROUND OF THE INVENTION

### 1. Field of the invention

The invention relates to an organic light-emitting diode (OLED) display; in particular, to a brightness compensation method applied to an OLED display.

### 2. Description of the prior art

Please refer to FIG. 1. FIG. 1 illustrates a circuit diagram of a display unit of a general OLED display panel. As shown in FIG. 1, the luminous brightness of an organic light-emitting diode OLED is related to the following factors:

(1) the current Ioled flowing through the organic light emitting diode OLED, and the current Ioled is proportional to the voltage difference of (the operating voltage ELVDD—the data voltage Vdata); and

(2) it is proportional to the duty cycle of the switch EMn.

Please refer to FIG. 2A and FIG. 2B. FIG. 2A and FIG. 2B respectively show timing diagrams of different methods to reduce the display frame of the OLED display panel without changing the gate and light emission control settings/hold time settings display frame rate.

As shown in FIG. 2A, the skip frame method is used to repeat the timing of the previous frame to reduce the display frame rate of the OLED display panel, but the repeated frame is not refreshed, and its extension is limited to the minimum unit of frame. Therefore, assuming the original frame rate of the OLED display panel is 60 Hz, if extending a repeated frame not refreshed, the frame rate of the OLED display panel becomes 60 Hz/2=30 Hz; if extending two repeated frames not refreshed, the frame rate of the OLED display panel becomes 60 Hz/3=20 Hz; the rest can be deduced by analogy.

As shown in FIG. 2B, the extend porch method is used to extend an extended porch period not refreshed according to a porch period of a previous frame to reduce the display frame rate of the OLED display panel, and its extension is limited to the minimum unit of EM pulse.

When the display screen of the OLED display panel is not refreshed, it is hoped that it can be displayed at a low frame rate to meet power saving requirements. Therefore, after displaying a frame at normal frame rate, methods of skipping frame or extending porch can be used to achieve low frame rate, and hope that the OLED display panel can maintain a consistent display brightness regardless of the normal frame rate or the low frame rate.

However, according to FIG. 1, it can be found that the data voltage Vdata is related to the charges stored in the capacitor in the OLED display panel. A low frame rate will cause charge leakage and make the data voltage Vdata become lower, thus changing the light-emitting brightness of the organic light-emitting diode OLED to make the picture brighter or darker. In other words, the difference between the high frame rate and the low frame rate will cause significant differences in the display brightness of the OLED panel, and when the OLED panel is at low frame rate, there will be bright and dark changes in the refreshed frames.

### SUMMARY OF THE INVENTION

Therefore, the invention provides a brightness compensation method applied to an OLED display to solve the above-mentioned problems of the prior arts.

A preferred embodiment of the invention is a brightness compensation method applied to an OLED display. In this embodiment, the brightness compensation method includes following steps of: (a) using a skip frame method to generate at least one repeated frame not refreshed to reduce a display frame rate of the OLED display from a first frame rate to a second frame rate, wherein the first frame rate is higher than the second frame rate; and (b) compensating pulse widths of N light-emitting control pulses corresponding to the at least one repeated frame, wherein the N light-emitting control pulses correspond to N compensation values, N≥1 and the N compensation values are positive or negative.

In one embodiment, a plurality of compensation values corresponding to a first repeated frame of the at least one repeated frame is different from each other.

In one embodiment, a plurality of compensation values corresponding to a first repeated frame of the at least one repeated frame is the same.

In one embodiment, a plurality of compensation values corresponding to a first repeated frame and a second repeated frame of the at least one repeated frame is different from each other.

In one embodiment, a first repeated frame and a second repeated frame of the at least one repeated frame correspond to a first compensation value and a second compensation value respectively, and the first compensation value is different from the second compensation value.

In one embodiment, the number of the plurality of compensation values is increased by frame.

Another preferred embodiment of the invention is a brightness compensation method applied to an OLED display. In this embodiment, the brightness compensation method includes following steps of: (a) using an extend porch method to generate an extended porch period not refreshed based on a porch period in a previous frame to reduce a display frame rate of the OLED display from a first frame rate to a second frame rate, wherein the first frame rate is higher than the second frame rate; and (b) compensating pulse widths of N light-emitting control pulses corresponding to the extended porch period, wherein the N light-emitting control pulses correspond to N compensation values, N≥1 and the N compensation values are positive or negative.

In one embodiment, a plurality of compensation values corresponding to the extended porch period is different from each other.

In one embodiment, a plurality of compensation values corresponding to the extended porch period is the same.

In one embodiment, every M compensation values in a plurality of compensation values corresponding to the extended porch period is set as a group, and M≥1.

In one embodiment, the number of the plurality of compensation values is increased by light-emitting control pulse.

Compared with the prior art, the invention proposes a brightness compensation method applied to an OLED display to compensate pulse widths of the light-emitting control pulses corresponding to the non-refresh period (e.g., repeated frame or extended porch period) generated when the display frame rate of the OLED display is reduced, so that the luminous brightness of the OLED at low display frame rate can be consistent with that at normal display frame rate, thereby effectively improving the display quality of the OLED display.

The advantage and spirit of the invention may be understood by the following detailed descriptions together with the appended drawings.

### BRIEF DESCRIPTION OF THE APPENDED DRAWINGS

FIG. 1 illustrates a circuit diagram of a display unit of a conventional organic light emitting diode display panel.

FIG. 2A and FIG. 2B illustrate timing diagrams of different methods for reducing the display frame rate of the organic light emitting diode display panel without changing the gate and light emission control setting/holding time setting respectively.

FIG. 3 illustrates a flowchart of a brightness compensation method applied to an OLED display according to an embodiment of the invention.

FIG. 4A illustrates a timing diagram when the display frame rate of the OLED display is at the normal frame rate of 60 Hz.

FIG. 4B illustrates a timing diagram when the display frame rate of the OLED display is reduced from the normal frame rate of 60 Hz of FIG. 4A to a low frame rate of 30 Hz by skipping frame.

FIG. 4C illustrates a timing diagram when the pulse widths of light-emitting control pulses corresponding to the repeated frame not refreshed in FIG. 4B are compensated.

FIG. 4D illustrates a timing diagram when the display frame rate of the OLED display is reduced from the normal frame rate of 60 Hz in FIG. 4A to a low frame rate of 20 Hz by skipping frames, the pulse widths of light-emitting control pulses corresponding to the first and second repeated frames not refreshed are compensated.

FIG. 4E illustrates a timing diagram when the display frame rate of the OLED display is reduced from the normal frame rate of 60 Hz in FIG. 4A to a low frame rate of 20 Hz by skipping frames, the pulse widths of light-emitting control pulses corresponding to the first and second repeated frames not refreshed are compensated.

FIG. 5A illustrates a timing diagram when the display frame rate of the OLED display is at the normal frame rate of 60 Hz.

FIG. 5B illustrates a timing diagram when the display frame rate of the OLED display is reduced from the normal frame rate of 60 Hz in FIG. 5A to a low frame rate of 24 Hz by extending porch.

FIG. 5C illustrates a timing diagram when the pulse widths of light-emitting control pulses corresponding to the extended porch period not refreshed in FIG. 5B are compensated.

FIG. 5D illustrates a timing diagram when the display frame rate of the OLED display is reduced from the normal frame rate of 60 Hz in FIG. 5A to a low frame rate of 20 Hz by extending porch, the pulse widths of light-emitting control pulses corresponding to the extended porch period not refreshed are compensated.

FIG. 5E illustrates a timing diagram when the display frame rate of the OLED display is reduced from the normal frame rate of 60 Hz in FIG. 5A to a low frame rate of 20 Hz by extending porch, the pulse widths of light-emitting control pulses corresponding to the extended porch period not refreshed are compensated.

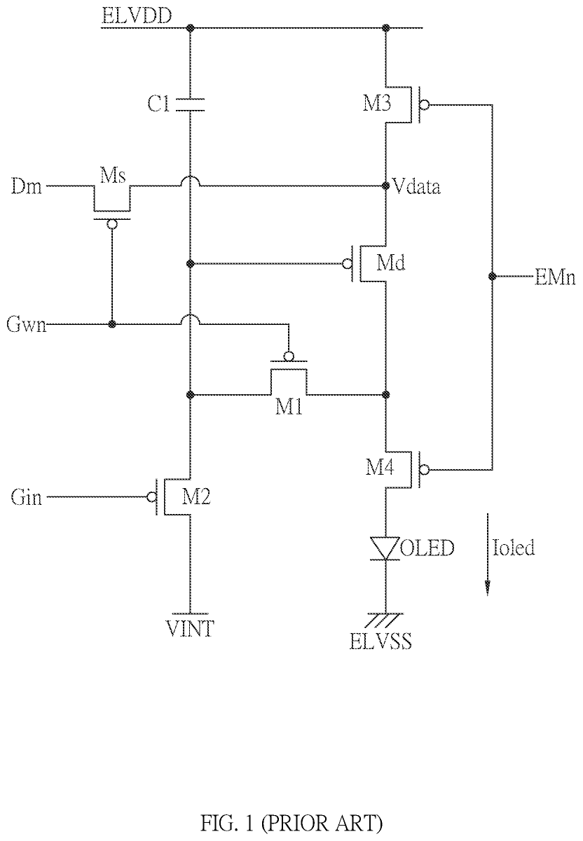

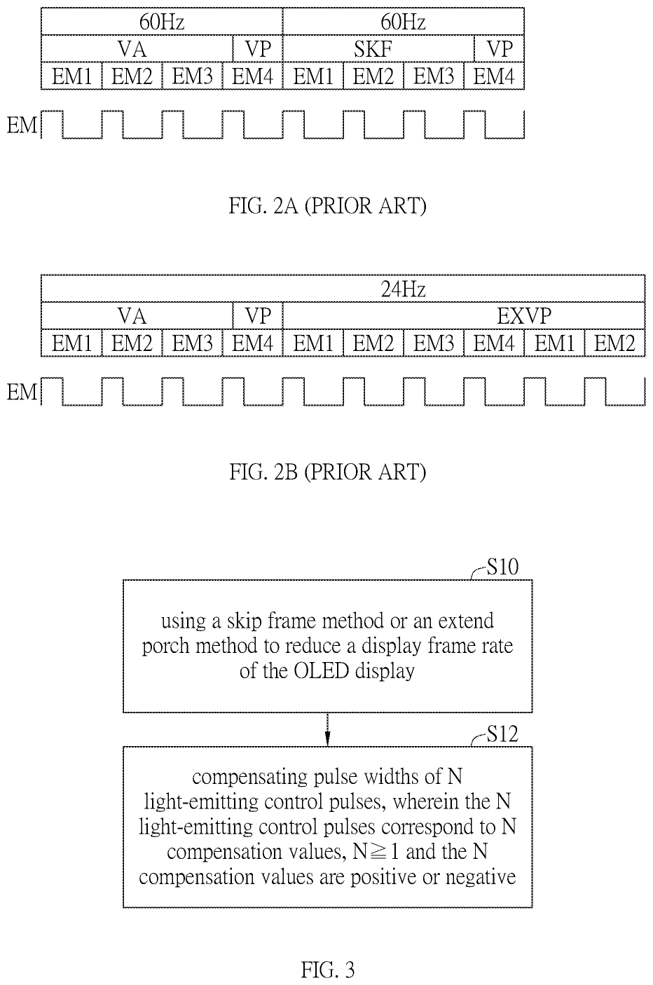

### DETAILED DESCRIPTION OF THE INVENTION

Reference will now be made in detail to exemplary embodiments of the present invention, and examples of the exemplary embodiments are illustrated in the accompanying drawings. Elements/components with the same or similar numbers used in the drawings and embodiments are used to represent the same or similar parts.

A specific embodiment of the invention is a brightness compensation method. In this embodiment, the brightness compensation method is applied to an OLED display. Please refer to FIG. 3, which illustrates a flowchart of the brightness compensation method applied to the OLED display in this embodiment.

As shown in FIG. 3, the brightness compensation method can include the following steps:

Step S10: using a skip frame method or an extend porch method to reduce a display frame rate of the OLED display from a first frame rate to a second frame rate, wherein the first frame rate is higher than the second frame rate; and

Step S12: compensating pulse widths of N light-emitting control pulses corresponding to the non-refresh period generated by the skip frame method or extend porch method, wherein the N light-emitting control pulses correspond to N compensation values, N≥1 and the N compensation values are positive or negative.

It should be noted that the method of reducing the display frame rate of the OLED display in the invention can be the skip frame method or extend porch method. Next, actual examples will be provided to illustrate these two different methods for reducing the display frame rate of the OLED display.

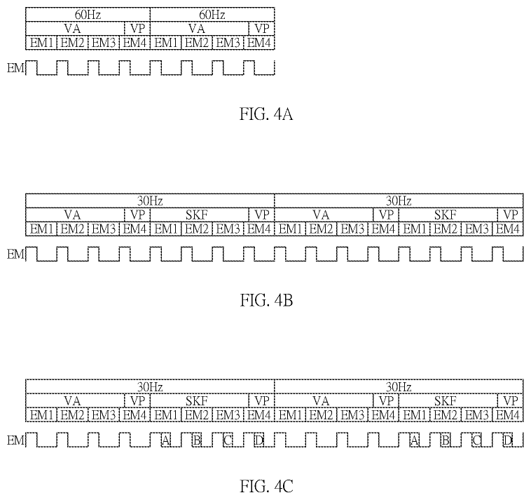

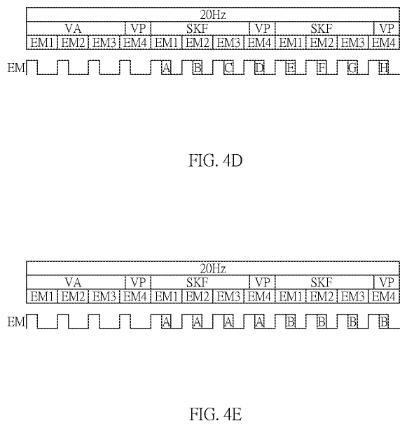

Please refer to FIG. 4A. FIG. 4A illustrates a timing diagram when the display frame rate of the OLED display is at the normal frame rate of 60 Hz.

As shown in FIG. 4A, the timing of a display frame with a normal frame rate of 60 Hz includes a refresh period VA and a non-refresh porch period VP, and it corresponds to four light emission control pulse periods EM1-EM4. The emission control pulse EM changes from low-level to high-level at the beginning of the emission control pulse periods EM1-EM4 and has the same pulse width.

As shown in FIG. 4B, when the display frame rate of the OLED display is reduced from the normal frame rate of 60 Hz in FIG. 4A to the low frame rate of 30 Hz through the skip frame method, the skip frame method generates a repeated frame not refreshed according to the display frame with the normal frame rate of 60 Hz in FIG. 4A, so that the display frame rate of the OLED display changes from 60 Hz in FIG. 4A to 30 Hz in FIG. 4B. It should be noted that the timing of the repeated frame includes a non-refresh period SKF and a porch period VP and corresponds to four light emission control pulse periods EM1-EM4.

Next, as shown in FIG. 4C, the invention will compensate the pulse widths of the four emission control pulse periods EM1-EM4 corresponding to the non-refreshed repeated frame in FIG. 4B respectively, and the compensation values are A, B, C and D. In other words, the invention can use different compensation values to compensate for different light emission control pulse periods, and the compensation value can be positive or negative (that is, the compensation for the pulse width can be to increase the pulse width or decrease the pulse width), but not limited to this. It should be noted that since the skip frame method is used to reduce the display frame rate of the OLED display, the number of these compensation values is increased by frame, but not limited to this.

In addition, as shown in FIG. 4D, when the display frame rate of the OLED display is reduced from the normal frame rate of 60 Hz in FIG. 4A to a low frame rate of 20 Hz through the skip frame method, the skip frame method generates a first repeated frame and a second repeated frame not refreshed in order according to the display frame with the normal frame rate of 60 Hz in FIG. 4A, so that the display frame rate of the OLED display can change from 60 Hz in FIG. 4A to 20 Hz in FIG. 4D. It should be noted that the timings of the first repeated frame and the second repeated frame both include a non-refresh period SKF and a porch period VP, and both correspond to four emission control pulse periods EM1-EM4. Next, the invention will compensate the pulse widths of the four light emission control pulse periods EM1-EM4 corresponding to the first repeated frame and the four light emission control pulse periods EM1-EM4 corresponding to the second repeated frame respectively. The compensation values are A, B, C, D, E, F, G and H respectively. In other words, the invention can use different compensation values to compensate for the light emission control pulse periods of different repeated frames, and the compensation value can be a positive or negative number (that is, the compensation for the pulse width can be to increase the pulse width or decrease the pulse width), but not limited to this.

In addition, as shown in FIG. 4E, when the display frame rate of the OLED display is reduced from the normal frame rate of 60 Hz in FIG. 4A to 20 Hz, the invention can use the same compensation value A to compensate the pulse widths of the four light emission control pulse periods EM1-EM4 corresponding to the first repeated frame not refreshed and use the same compensation value B to compensate the pulse widths of the four light emission control pulse periods EM1-EM4 corresponding to the second repeated frame not refreshed. In other words, the invention can use the same compensation value for the lighting control pulse periods of the same repetitive frame, but different compensation values are used for the lighting control pulse periods of different repetitive frames, and the compensation values can be a positive or negative number (that is, the compensation can be to increase the pulse width or decrease the pulse width), but not limited to this.

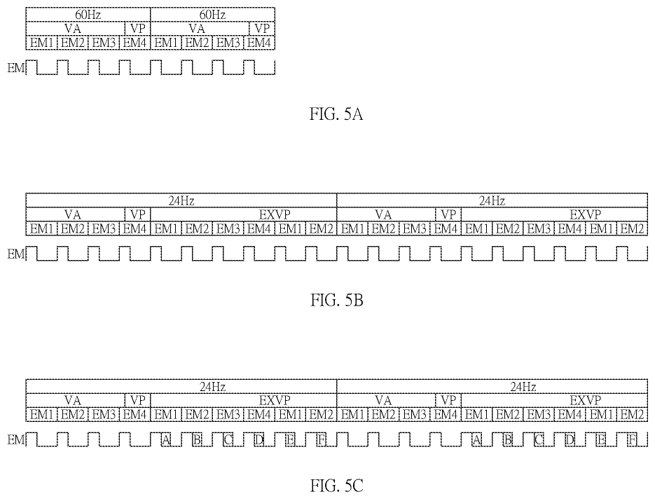

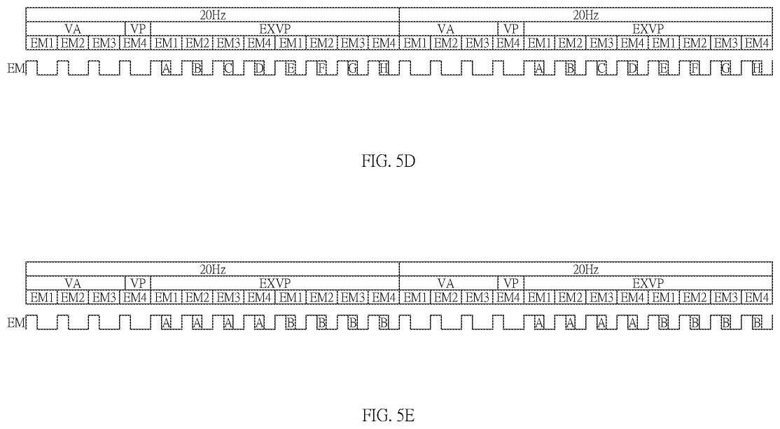

Please refer to FIG. 5A. FIG. 5A illustrates a timing diagram when the display frame rate of the OLED display is at the normal frame rate of 60 Hz.

As shown in FIG. 5A, the timing of a display frame with the normal frame rate of 60 Hz includes a refresh period VA and a porch period VP and corresponds to four light emission control pulse periods EM1-EM4. The light-emission control pulse EM changes from low-level to high-level at the beginning of the light-emission control pulse periods EM1-EM4 and has the same pulse width.

As shown in FIG. 5B, when the display frame rate of the OLED display is reduced from the normal frame rate of 60 Hz in FIG. 5A to the low frame rate of 24 Hz through the extend porch method, the extend porch method generates a non-refreshed extended porch period EXVP corresponding to six light emission control pulse periods according to the porch period VP in the display frame with the normal frame rate of 60 Hz in FIG. 5A, so that the display frame rate of the OLED display changes from 60 Hz in FIG. 5A to 60 Hz*4/(4+6)=24 Hz in FIG. 5B.

Next, as shown in FIG. 5C, the invention will compensate the pulse widths of the six emission control pulse periods corresponding to the non-refreshed extended porch period EXVP in FIG. 5B, and the compensation values are A, B, C, D, E and F respectively. In other words, the invention can use different compensation values to compensate for different light emission control pulse periods, and the compensation values can be positive or negative (that is, the compensation for the pulse width can be to increase the pulse width or decrease the pulse width), but not limited to this. It should be noted that since the extend porch method is used to reduce the display frame rate of the OLED display, the extended porch period EXVP can include different numbers of light-emitting control pulses according to actual needs; that is, the number of compensation values is increased by light-emitting control pulse, but not limited to this.

In addition, as shown in FIG. 5D, when the display frame rate of the OLED display is reduced from the normal frame rate of 60 Hz in FIG. 5A to a low frame rate of 20 Hz through the extend porch method, the extend porch method generates a non-refreshed extended porch period EXVP corresponding to eight emission control pulse periods according to the porch period VP in the display frame with the normal frame rate of 60 Hz in FIG. 5A, so that the display frame rate of the OLED display changes from 60 Hz in FIG. 5A to 60 Hz*4/(4+8)=20 Hz in FIG. 5D. Next, the invention will compensate the eight emission control pulse periods corresponding to the non-refreshed extended porch period EXVP respectively, and the compensation values are A, B, C, D, E, F, G and H respectively. In other words, the invention can use different compensation values to compensate for different light emission control pulse periods, and the compensation values can be positive or negative (that is, the compensation for the pulse width can be to increase the pulse width or decrease the pulse width), but not limited to this.

In addition, as shown in FIG. 5E, when the display frame rate of the OLED display is reduced from the normal frame rate of 60 Hz in FIG. 5A to the low frame rate of 20 Hz through the extend porch method, the invention will compensate for the eight emission control pulse periods corresponding to the extended porch period EXVP not refreshed. Every M compensation values in the compensation values can be set as a group (M≥1). Assuming M=4, the compensation values can be A, A, A, A, B, B, B and B. The invention can use the same compensation value in the same group to compensate for the light-emitting control pulse periods, but different compensation values are used in different groups to compensate for the light-emitting control pulse periods, and the compensation values can be a positive or negative number (that is, the compensation for the pulse width can be to increase the pulse width or to reduce the pulse width), but not limited to this.

Compared with the prior art, the invention proposes a brightness compensation method applied to an OLED display to compensate pulse widths of the light-emitting control pulses corresponding to the non-refresh period (e.g., repeated frame or extended porch period) generated when the display frame rate of the OLED display is reduced, so that the luminous brightness of the OLED at low display frame rate can be consistent with that at normal display frame rate, thereby effectively improving the display quality of the OLED display.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A brightness compensation method applied to an OLED display, comprising steps of:
(a) using a skip frame method to generate at least one repeated frame not refreshed to reduce a display frame rate of the OLED display from a first frame rate to a second frame rate, wherein the first frame rate is higher than the second frame rate; and
(b) compensating pulse widths of N light-emitting control pulses corresponding to the at least one repeated frame, wherein the N light-emitting control pulses correspond to N compensation values, N≥1 and the N compensation values are positive or negative.

2. The brightness compensation method of claim 1, wherein a plurality of compensation values corresponding to a first repeated frame of the at least one repeated frame is different from each other.

3. The brightness compensation method of claim 1, wherein a plurality of compensation values corresponding to a first repeated frame of the at least one repeated frame is the same.

4. The brightness compensation method of claim 1, wherein a plurality of compensation values corresponding to a first repeated frame and a second repeated frame of the at least one repeated frame is different from each other.

5. The brightness compensation method of claim 1, wherein a first repeated frame and a second repeated frame of the at least one repeated frame correspond to a first compensation value and a second compensation value respectively, and the first compensation value is different from the second compensation value.

6. The brightness compensation method of claim 1, wherein the number of the plurality of compensation values is increased by frame.

7. A brightness compensation method applied to an OLED display, comprising steps of:
(a) using an extend porch method to generate an extended porch period not refreshed based on a porch period in a previous frame to reduce a display frame rate of the OLED display from a first frame rate to a second frame rate, wherein the first frame rate is higher than the second frame rate; and
(b) compensating pulse widths of N light-emitting control pulses corresponding to the extended porch period, wherein the N light-emitting control pulses correspond to N compensation values, N≥1 and the N compensation values are positive or negative.

8. The brightness compensation method of claim 7, wherein a plurality of compensation values corresponding to the extended porch period is different from each other.

9. The brightness compensation method e of claim 7, wherein a plurality of compensation values corresponding to the extended porch period is the same.

10. The brightness compensation method of claim 7, wherein every M compensation values in a plurality of compensation values corresponding to the extended porch period is set as a group, and M≥1.

11. The brightness compensation method of claim 7, wherein the number of the plurality of compensation values is increased by light-emitting control pulse.
